(19) United States
(12) Patent Application Publication
(10) Pub. No.: US 2005/0255606 A1
(43) Pub. Date: Nov. 17, 2005

(54) Methods for accurate component intensity extraction from separations-mass spectrometry data

(75) Inventors: Zulfikar Ahmed, San Francisco, CA (US); Hans Bitter, San Francisco, CA (US); Michael Brown, San Francisco, CA (US); Jonathan C. Heller, San Francisco, CA (US); David Donoho, Stanford, CA (US); Jim Quarato, Sunnyvale, CA (US); Arjuna Balasingham, San Francisco, CA (US); David Perry De Valpine, San Francisco, CA (US)

Correspondence Address: WILSON SONSINI GOODRICH & ROSATI, 650 PAGE MILL ROAD, PALO ALTO, CA, 94304-1050, US

(73) Assignee: Biospect, Inc., a California Corporation, South San Francisco, CA (US)

(21) Appl. No.: 10/846,996

(22) Filed: May 13, 2004

(51) Int. Cl. G01N 24/00

(52) U.S. Cl. 436/173

(57) ABSTRACT

The present invention discloses methods for deconvolving and converting 1D mass spectra to 2D mass spectrum in order to obtain migration time centers and total intensities of the neutral mass envelopes of 2D spectra. The present invention also discloses devices that include a preparation/separation unit coupled to a mass spectrometer unit, and a computer unit capable of deconvolving mass spectra and calculating neutral mass envelopes.

### BACKGROUND OF THE INVENTION

Mass spectrometry has become increasingly important in the field of proteomics. Mass spectromentry can be used, for example, for protein sequencing, sample analysis, functional group identification, phenotyping, etc. There are various mass spectrometers available commercially. Most mass spectrometers are based on the following four key features: a sample inlet, an ionization source, a mass analyzer, and an ion detector. Different mass spectrometer instruments may combine the above four features in different ways, but all mass spectrometers function by introducing a sample of molecules into the instrument, ionizing the same molecules to convert molecules into ions, propelling the ions into the analyzer where they are separated, detecting the ions according to their mass-to-charge ratio (m/z).

There are many forms of ionization. Examples of commonly used forms of ionization include, but are not limited to, electrospray ionization (ESI), nanoelectrospray ionization (nanoESI), atmospectric pressure chemical ionization (APCI), matrix-assisted laser desorption/ionization (MALDI), desorption/ionization on silicon (DIOS), fast atom/ion bombardment (FAB), electron ionization (ED), and chemical ionization (CI). In preferred embodiments, a mass spectrometer is an ESI or a MALDI mass spectrometer. ESI generates a fine spray of charged droplets in the presence of an electric field by converting a liquid solution to a gas. ESI can produce singly charged small molecules (e.g., a small peptide) as well as multiply charged larger molecules (e.g., a protein). Recently, nanoelectrospray or nanospray has also been with a mass spectrometer. Nano-electrospray can involve the use of a spray needle that has a flow rate of approximately 1-100 or more preferably 1-10 nanoliters per minute. An electrospray ionization time-of-flight mass spectrum has a number of difficulties that must be overcome before a neutral mass spectrum may be obtained.

Just as there are many forms of ionization sources, there are also many types of mass analyzers. Examples of commonly utilized mass analyzers include, but are not limited to, quadrupole, quadrupole ion trap, time-of-flight (TOF), time-of-flight reflectron (TOFR), Quad-TOF, magnetic sector, Fourier transform ion cyclotron resonance (FTMS or FT-ICR). While different mass analyzers operate in different ways (e.g., some separate ions in space others separate ions in time), all mass analyzers measure the relative intensity of gas phase ions according to their m/z ratios.

For example, a quadrupole mass analyzer involves the use of four rods, two positively charged and two negatively charged, wherein similarly charged rods are lined up opposite of each other. Ions generated from an ionization source are forced in between the four rods, superimposed by radio frequency. A quadrupole ion trap mass analyzer is similar to a quadrupole mass analyzer, however, instead of passing through a quadrupole analyzer with a superimposed radio frequency, the ions are trapped in a radio frequency quadrupole field. Quadrupole ion traps commonly employ an ESI or MALDI ionization source.

A TOF mass analyzer detects the time it takes ions to reach a detector. Ions in a TOF mass analyzer are given the same amount of energy through an accelerating potential. This allows for lighter ions to reach the detector faster than heavier ions of equal charge state. A modification of the TOF analyzer is the TOF reflectron analyzer. The TOF reflectron analyzer adds an electrostatic mirror that functions to increase the amount of time ions need to reach the detector while reducing their kinetic energy distribution and temporal distribution. Since mass resolution is defined by mass-to-charge of a peak divided by Δm, where Δm is the full width at half height (or t/2Δt since m is related to t quadratically), increasing t and decreasing Δt results in higher resolution. TOF and TOF reflectron mass analyzers function well with ESI, MALDI, and other ionization sources.

Another common mass analyzer is the Fourier transform-ion cylotron resonance (FTMS or FT-ICR). FTMS is based on the concept of monitoring a charged particle as it orbits in a magnetic field. While the ion is orbiting, a pulsed radio frequency (RF) signal is used to excite the ions and produce a detectable current. The image current generated by all of the ions is then Fourier-transformed to obtain the component frequencies of the different ions. When a mixture of ions with different m/z values are simultaneously accelerated, the image current signal at the output of the amplifier is a composite transient signal with frequency components representing each m/z value. See Siuzdak, G., “The Expanding Role of Mass Spectrometry in Biotechnology,” (MCC Press, San Diego, 2003).

No matter which mass spectrometer is used to analyze a sample, its output will have a spreading or loss of resolution and some noise (e.g., white noise and poisson noise) associated with it. These make it difficult to accurately analyze data and distinguish one charged molecule from another. Thus, the present invention provides, in part, methods for obtaining neutral mass spectra that have much better resolution and much reduced noise than the raw data.

### SUMMARY OF THE INVENTION

The present invention contemplates methods for processing mass spectra data comprising performing a deconvolution of a one-dimensional (1D) spectrum to increase the mass resolution of the raw data accurately and to reduce or remove the noise in the spectrum. Deconvolution of mass spectra output is preferably made using maximum entropy estimation or basis pursuit (BP). The axis of the original 1D spectrum, e.g. the TOF axis, may be transformed prior to deconvolution and re-transformed subsequent to deconvolution. Need a sentence that says that a collection of 1d spectra can form a 2d data set.

In some embodiments, clustering analysis is preformed on the two-dimensional data set subsequent to deconvolution of the 1D mass spectra output. The role of clustering is to accurately represent the different peaks represented across time in a 2D separations-mass spectrum and to obtain an accurate count of these peaks.

In some embodiments, deconvolved, clustered peak lists are further processed to group isotopes and charge states observed for distinct molecular ion species.

In preferred embodiments, the results of deconvolution of mass spectra output accurately represent the molecular ion species detected from the sample. In preferred embodiments, 50% of the resulting peaks represent molecular ions detected in the sample, more preferably at least 70%, more preferably at least 80%, more preferably at least 90%, more preferably at least 95%, or more preferably at least 99%. In preferred embodiments, 50% of the molecular ion detected from the sample are represented by resulting peaks, more preferably at least 70%, more preferably at least 80%, more preferably at least 90%, more preferably at least 95%, or more preferably at least 99%.

In preferred embodiments, the results of deconvolution, clustering, and grouping isotopes and charge states accurately represent the neutral mass molecular species detected from the sample. In preferred embodiments, 50% of the resulting peaks represent molecular species detected in the sample, more preferably at least 70%, more preferably at least 80%, more preferably at least 90%, more preferably at least 95%, or more preferably at least 99%. In preferred embodiments, 50% of the molecular ion detected from the sample are represented by resulting peaks, more preferably at least 70%, more preferably at least 80%, more preferably at least 90%, more preferably at least 95%, or more preferably at least 99%.

### BRIEF DESCRIPTION OF THE DRAWINGS

FIG. 1A represents a “cluster” or a group of isotopes (e.g., a, b, and c) of the same charge state of a species. FIG. 1B represents different charge states (e.g., A-E) of a species. A single charge state can comprise of a single isotope as is illustrated in FIG. 1B or multiple isotopes as is illustrated in FIG. 1A.

FIG. 2 illustrates a flow diagram of a high-throughput online system disclosed herein.

FIG. 3 illustrates the process of scaling, deconvolving, and descaling. FIG. 3A is a 1D spectrum before scaling (raw data). FIG. 3B is a 1D spectrum after scaling but before deconvolving. FIG. 3C is a 1D spectrum after deconvolving but before descaling. FIG. 3D is a 1D spectrum after deconvolving and descaling.

FIG. 4 illustrates the process of compiling multiple 1D spectra into a 2D spectrum. FIG. 4A illustrates the compilation of multiple 1D spectra such that similarly situated peaks are aligned vertically. FIG. 4B illustrates a compiled 2D spectrum of more than 20 individual 1D spectra.

FIG. 5 illustrates a list of data output that may be generated by the methods herein. FIG. 5, Column 1, lists centroid mass values; FIG. 5, Column 2, lists the centroids in separation time value; and FIG. 5, Column 3, lists the total intensity for those deconvolved, collapsed peaks.

FIG. 6 illustrates an overview of a high-throughput online system disclosed herein.

### DETAILED DESCRIPTION OF THE INVENTION

The present invention involves a high-throughput method that allows for the diagnosis and prognosis of various diseases, research for discovery of proteomic markers whose levels in biological samples can statistically distinguish between healthy and disease states as well as between different disease states, and identification of novel compositions that may function as targets or therapeutics in the treatment and management of diseases.

In particular, the present invention relates to methods to determine accurate estimates of the total intensity (abundance), average and carbon-12 monoisotopic as well as average molecular weight, mass-to-charge ratio, and isotopic composition of molecular ion species present in a raw separations-mass spectrum. This allows for summarizing the information of large multidimensional spectra by output data that are several orders of magnitude smaller in size.

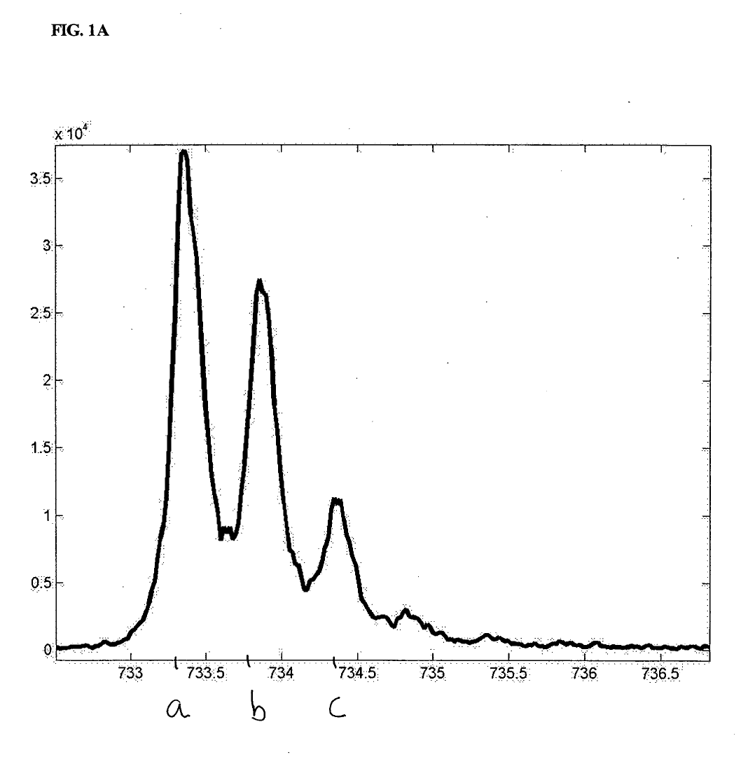

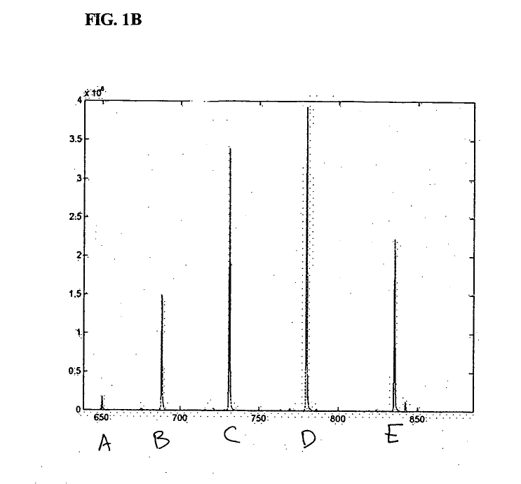

A common feature of electrospray ionization mass spectrometry is the ability of the mass spectrometer to produce ions with multiple charge states. An ESI mass spectrum generally comprises of a sequence of multiply charged peaks. Each group of peaks in a one-charge state is often referred to as an isotope envelope. An envelope is a cluster of peaks for a given charge state representing all of the different observable isotope states of a particular molecule. An envelope represents one charge state of a molecule. Thus, multiple envelopes may represent one molecule in its different charge states. FIGS. 1A and 1B illustrate the above concepts. FIG. 1A represents a single charge state of a species. The charge state comprises of a set of peaks (e.g., a, b, and c). Each peak represents a different isotope of the charge state. FIG. 1B represents different charge states (A-E) of the same species. The species illustrated by FIGS. 1A and 1B are not the same.

The capacity of a mass analyzer to differentiate between masses is usually expressed in terms of its mass resolution, which is defined as R=m/Δm, wherein Δm is the full width at half height of the peak and m is the nominal mass-to-charge ratio of the first peak. Mass analyzers are finite resolution instruments and hence, instead of producing a sharp width-less spike for each ion species, they produce a positive-width lineshape or pointspread function whose width depends on the mass-to-charge of the species, the species' temporal and energy distributions, and on the instrumental configuration for each m/z species. An instrument that cannot resolve different isotopes will generate a broad peak where individual isotopes will not be visually resolvable, with the center representing the approximate average mass of all isotopes. Furthermore, peaks from two different envelopes with mass-to-charge centers (or “centroids”) may overlap. Overlapping envelopes can sometimes make it difficult to distinguish each envelope. The task of extracting the underlying isotope mass-to-charges and their abundances from an unresolved envelope is often referred to as a problem of “super-resolution”.

In addition to resolution problems, a mass spectrometer may also produce noise that can distort the spectrum. Examples of noise include “white noise” (usually modeled as “Gaussian noise”) and “detector noise” (usually modeled as “poisson noise”). White noise can result from various internal errors that can influence an entire data set. White noise can occur, for example, as a result of an imperfect vacuum, impurities in the device or sample, insufficient concentration of sample, temperature, etc. For a particular 1D spectrum, the white noise may be independent on the signal intensity. Unlike white noise, detector noise may depend on the intensity of the signal.

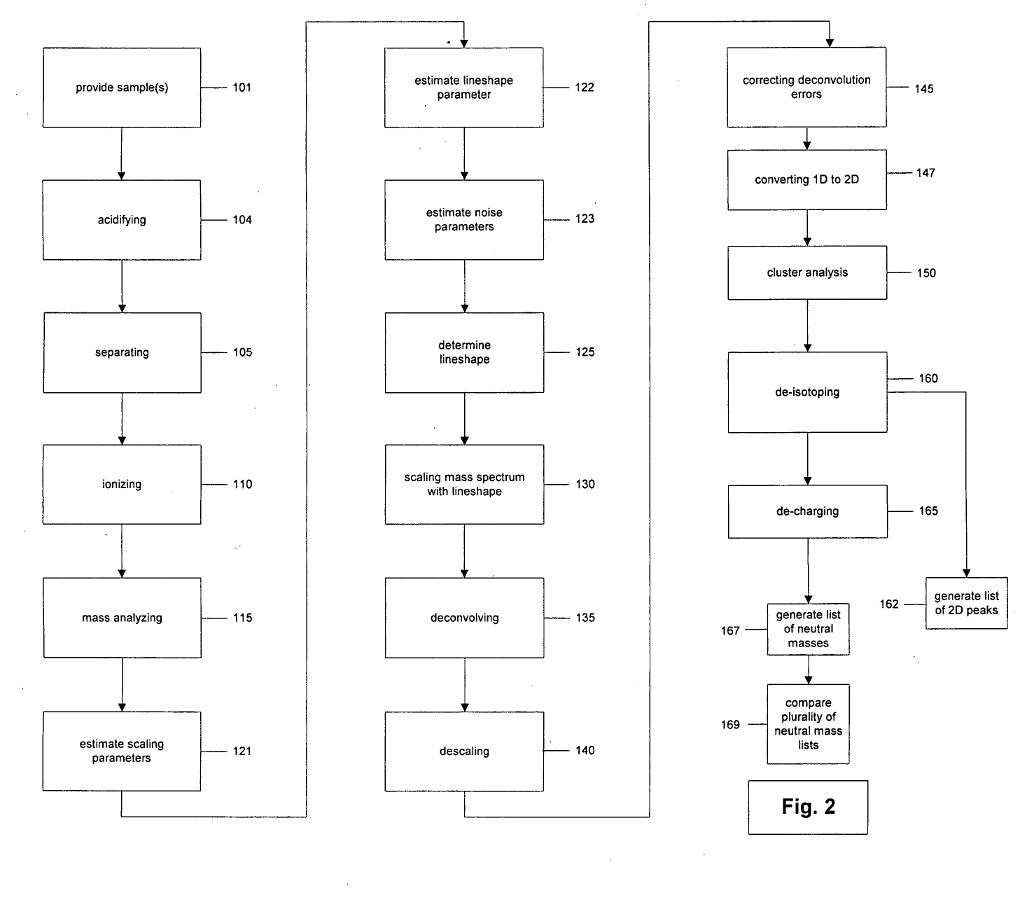

The present invention involves high throughput methods using a measured mass spectrum to estimate the signal for the same sample that would be produced by a mass spectrometer with a higher resolution and with lower noise levels, with the limit of an idealized mass spectrometer which gives exact estimates of location and intensity for each charge state and each isotope of every molecular species in the sample. An overview of the methods herein is described in FIG. 2.

The methods herein involve analyzing one or more samples 101. Preferably, the methods herein involve high throughput screening of numerous samples. A sample analyzed by a mass spectrometer of the present invention can include one or more compositions including, a carbohydrate, a polypeptide, a polynucleotide, a lipid, a synthetic polymer, a small or large organic or inorganic molecule, a mimetic, or a combination of any of the above. Preferably a sample is obtained from a plant or an animal, more preferably from a mammal, or more preferably from a human. Examples of liquid samples that may be derived from an individual include urine, nasal discharge, vaginal discharge, mucus, lymph, blood, serum, plasma, saliva, and tears. Non-liquid samples may also be used as a non-liquid sample may be solubilized.

A sample may be input directly into the mass spectrometer for analysis or, in preferred embodiments, it may be first separated in step 105. Separation may be made according to, for example, size, weight, charge, isoelectric point, binding affinity, time of travel, etc. A sample can be separated using, for example, electrophoresis, chromatography, filtration, centrifugation, fractionation, antibodies, or any other means for separating in time various components of the sample.

In preferred embodiments, samples are separated by electrophoresis or chromatography, more preferably samples are separated by capillary electrophoresis (CE) or high performance liquid chromatography (HPLC). Capillary electrophoresis refers to a set of related techniques that employ capillaries (e.g., 10-200 μm i.d. in width) to perform high efficiency separations. CE can be used to separate both large and small molecules. CE techniques perform separations based on, for example, molecular size, isoelectric focusing, and hydrophobicity. In particular, high voltages may be used to separate molecules based on differences in charge and size. For example, in free-zone CE, separation results from the combination of electrophoretic migration and electro-osmotic flow. In preferred embodiments, CE is performed for example on a P/ACE™ MDQ (Beckman Instrument). Electrophoresis can also be performed on microfluidic chips with channels of smaller dimensions.

In some embodiments, the separation step can be repeated more than one, two, three, or four times. Each time a separation step is repeated the same or a different separation technique may be utilized. In preferred embodiments, samples are separated twice or three times using capillary electrophoresis and/or HPLC. The greater the number of separations used the greater the number of dimensions produced by the output of the mass spectrometer. However, no matter how many separations are conducted the mass spectrum output may be deconvolved line-by-line as a 1D spectrum as described in more detail herein.

Furthermore, in preferred embodiments, the separation step may be preceded by an acidification step 104. In some embodiments, a liquid sample is acidified to denature proteins therein thereby breaking up complexes. The sample is then filtered or separated to remove a subset of species before separating it (e.g., by capillary electrophoresis). The acidification step may be followed by a separation step 105 by ultracentrifugation and/or ultrafiltration. This allows for a crude separation of components into fractions to be analyzed further and unwanted fractions.

Acidification may occur with acids that will not cleave desired proteins. Preferably acids used for acidification reduce the acidity of the sample to no less than pH5, pH4, pH3, or pH2. For example, formic acid may acidify a sample to a pH of 3. It is then possible to separate unwanted constituents in the sample by ultracentrifugation. Fractionation of the liquid sample yields the result that, for example, only fractions of e.g., proteins and/or peptides of a certain molecular weight are retained for further analysis.

Alternatively or additionally, proteins may be digested with proteases, e.g. trypsin, or by other means and those protein fragments may then be separated and analyzed by mass spectrometry. Information from such digestion experiments can help analyze larger proteins.

Separation step 105 is preferably automated and followed by the ionization step 110. The ionization step 110 involves producing gas phase ions from analyte in solid or liquid phase. There are numerous methods for ionizing a sample 110. Commonly used ionization methods include those disclosed herein, such as electrospray, nanoelectrospray, or MALDI. More preferably, a sample in solution is ionized by electrospray or nanoelectrospray. In other embodiments, a MALDI ionization source is used.

After ionization step 110, a mass analyzer analyzes ionized samples/fragments in step 115. For the purposes of the invention herein, any mass analyzer may be used to analyze the resulting ions. However, in preferred embodiments, the mass analyzer is a TOF mass analyzer or an FTMS mass analyzer.

The mass analyzer may be a tandem mass spectrometer as well, in which mass spectrometry is essentially performed twice. Species selected after the first mass analysis are fragmented and the fragments are analyzed in the second mass analyzer. This type of analysis can be helpful, for example, in identifying proteins. There are many forms of tandem mass spectrometers, including for example, quadropole-TOF mass spectrometers.

Output from a coupled separations-mass spectrometer system can include both a “1-dimensional (1D) mass spectrum” wherein m/z values are in the x-axis and intensity values are in the y-axis, and “2-dimensional (2D) mass spectrum,” wherein m/z values are in the x-axis the migration time is in the y-axis, and contours or colors represent intensities.

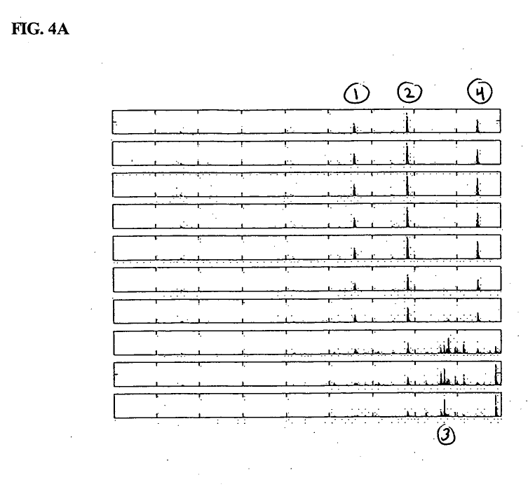

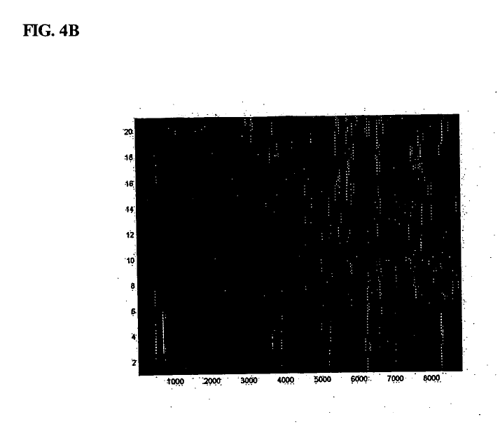

The process of compiling a 2D mass spectrum from multiple 1D spectra is illustrated in FIGS. 4A and 4B. FIG. 4A illustrates the compilation of multiple 1D spectra such that similarly situated peaks are aligned vertically. FIG. 4B illustrates a compiled 2D spectrum of more than 20 individual 1D spectra. Any number of 1D spectra can be compiled into a 2D spectrum.

The invention preferably utilizes separations procedures that allow elution of a single molecular species for longer than the acquisition time of a single mass spectrum. Preferably peaks for the various charge states of a species appear in more than 1, more than 2, more than 3, more than 4, more than 5, or more preferably more than 10, more than 15, or more than 20 contiguous 1D spectra in similar m/z locations. By configuring the 1D spectrum to illustrate similar m/z's together, a 2D spectrum, which has “2D peaks” that depend on the mass to charge and the separation time axis is formed.

The 1D spectrum may be analyzed by determining a lineshape for the 1D mass spectrum in step 125, transforming (scaling) the lineshape signal to an axis wherein the peaks have similar shape and width independent of the m/z of the species in scaling step 130, deconvolving the scaled lineshape in step 135, and descaling the output of deconvolution in step 140 back to the original mass spectrum axis.

In preferred embodiments, scaling parameters, lineshape parameters, and noise levels are estimated in steps 121, 122, and 123, prior to determination of a lineshape.

In some embodiments, scaling parameters are estimated in step 121 by fitting a statistical model where a parameter a represents the change of peak-widths as a function of time-of-flight. A subset of data from a 2D separations-spectrum is chosen judiciously based on whether they contain resolved isotope clusters. Then a statistical fit for α is made depending on a collection of fits to isotope clusters with time-of-flight centers that cover a wide range.

In some embodiments, lineshape parameters are estimated in step 122 based on parametric and non-parametric methods. For example, estimation of known lineshape parameters is done using physical parameters of the mass spectrometer and statistical distributions of the locations, velocities, and other physical parameters of the particles and of the mass spectrometer. Statistical estimation of the unknown lineshape parameters is done by standard methods such as maximum likelihood, least squares, maximum entropy, and/or model selection methods such as information criteria.

In preferred embodiments noise levels are estimated in step 123 by high frequency wavelet coefficients of the signal. In other embodiment, noise levels are estimated by any well-known method in signal processing.

Methods for estimating lineshape parameters are disclosed in U.S. application Ser. No. 10/462,228, filed on Jun. 12, 2003, entitled “Method And Apparatus For Modeling Mass Spectrometer Lineshapes,” incorporated herein by reference for all purposes.

In step 125 a mass spectrum lineshape is determined. Certain methods of determining lineshape are provided in U.S. application Ser. No. 10/462,228, filed on Jun. 12, 2003, entitled “Method And Apparatus For Modeling Mass Spectrometer Lineshapes,” incorporated herein by reference for all purposes, which discloses analytic models to determine some envelopes of lineshapes. The present invention further provides additional methods for calculating and/or estimating a lineshape u by estimating parameters that define such lineshape from data. Each of the methods disclosed herein may be used independently or in combination with other methods.

In one embodiment, a lineshape u is calculated based on physical parameters of the mass spectrometer/separation-mass spectrometry system and statistical distributions of the locations, velocities, and other physical parameters of the particles and of the mass spectrometer/separation-mass spectrometry. For particular settings of a mass spectrometer for which a well-understood physics model is available, this method allows calculation of the parameters that define u from data with statistical bounds representing confidence of the fit of the model.

In a second embodiment, a lineshape u is calculated by combining physical derivation of the lineshape with statistical estimation of unknown features of the lineshape. In this approach, physical derivation may leave some features of the lineshape unspecified, such as a reference width, tail shape, or other features. The unspecified features may be estimated by statistically fitting u to a selected subset of single peaks or isotopic peak clusters. A useful analogy for this approach is estimation of standard statistical distributions such as a normal distribution where the mean and variance are estimated from data; the distribution is specified as a parametric envelope with parameters to be estimated from data. Here the lineshape is derived as a parametric envelope from understanding of the mass spectrometer, with some parameters to be estimated from data.

For a given set of parameters for the lineshape and parameters for the locations and intensities of the subsample of peaks or isotopic peak clusters, a likelihood for such set of parameters (or sum of squares, or other statistical fitting function) can be calculated for the data, and the best parameters can be selected by optimizing the likelihood (or other fitting function). The parameters to be estimated can also be formulated as unknown physical parameters of the mass spectrometer/separation-mass spectrometry. A lineshape can be calculated, from which the value of the statistical fitting function can be calculated and optimized over the parameter space.

In a third embodiment a lineshape u is determined completely from raw data by relying exclusively on statistical estimation of the lineshape using flexible non-parametric methods for estimation of arbitrary distribution functions. This method omits physical derivation of any aspects of the lineshape, and the three methods specified here represent a spectrum from completely physical derivation to combined physical and statistical estimation to completely statistical estimation. To estimate u completely statistically, flexible functional forms such as smoothing splines, B-splines, thin plate splines, piecewise polynomials, and mixtures of distributions may be used.

The lineshape can be considered a multiple of a probability density function. The methods of the last paragraph can be used to estimate either the probability density function or the logarithm of the probability density function. Each of these methods involves parameters to be estimated, and some involve smoothness penalties that can be chosen manually or by automated methods such as cross-validation. For any given parameters, the density function estimator produces a particular lineshape, for which a likelihood (or other fitting function) can be calculated for the data, and the best parameters can be selected by optimizing the likelihood (or other fitting function) over the parameter space.

After u is determined, the 1D spectra is scaled or transformed in step 130. Scaling step 130 transforms the u along the time-of-flight-axis.

In some embodiments, scaling step 130 transforms the lineshape along the time-of-flight-axis such that the peaks have the same shape and width independent of the m/z of the species or time-of-flight. This allows use of Fourier transform techniques to deconvolve the spectrum, since the blurring effect of the mass spectrometer is independent of the location in the transformed coordinates. This is especially useful when using a single-extraction time-of-flight mass spectrum, which generates peaks widths that increase linearly as a function of the time of flight.

Configurations of the mass spectrometer that have more than one acceleration region produce peak widths that do not necessarily increase linearly but are well-behaved and deterministic as a function of mass-to-charge. Thus, in some embodiments, scaling step 130 involves transforming the lineshape of a spectrum to an artificial axis where the peak-widths of the underlying individual isotopes of each species will be constant and the lineshape is transformed along the time-of-flight-axis such that lineshape u varies deterministically.

For example, when using a TOF mass spectrometer with a single acceleration region, the present invention provides for a F(t) that is a continuous function of time-of-flight, t, representing a signal with a fixed lineshape or point-spread function with the property that the peak centered at t₀ has peak width a t₀+b, where a>0. In this case, the function

$$S ↦ F ( ( t ( 0 ) + \frac{b}{a} ) exp ( a S ) - \frac{b}{a} )$$

has peak widths that are constant. In other word, in the coordinate

$$S = \frac{1}{a} log ( \frac{a t + b}{a t ( 0 ) + b} )$$

the function F has constant peak width. But peak areas of F(t(s)) are not the same as the corresponding peak areas of F(t). The transformation that also preserves peak areas is

$$\tilde{F} ( S ) = \frac{exp ( - a S )}{a t ( 0 ) + b} F ( ( t ( 0 ) + \frac{b}{a} ) exp ( a S ) - \frac{b}{a} )$$

In some embodiments, scaling step 130 transforms the lineshape along the time-of-flight-axis such that the width of lineshape u varies linearly or quadratically as a function of time-of-flight. Linear or quadratic parameters may be calculated from raw data using a parametric model of the lineshape. In some embodiments, the parametric model can be determined using a model of the lineshape that includes initial position and energy distribution of charged ions. In some embodiments, the parametric model can be gaussian. In some embodiments, the parametric model can be a student-t distribution. In some embodiment, the parametric model can be determined by computer simulation of the mass spectrometer.

After scaling an observed signal, the scaled signal is deconvolved.

The scaled signal is termed y, as represented by the following formula:
y=u*x+σw
wherein u is assumed to be a known, scaled lineshape or point-spread function, σ is assumed to be the standard deviation of the white noise, x is the unknown “true signal”, and w is N(0,1) white noise. The operator Kx=u*x may be singular or at least numerically singular, and hence the problem of determining y even in the case where a is zero is not a well-posed problem.

After scaling step 130, a scaled lineshape u, is deconvolved in step 135. One could use any method known in the art for deconvolution of a mass spectrum with the lineshape.

In some embodiments, deconvolution is made by parametric deconvolution techniques (PDPS). PDPS is described in more detail in (Li et al., 2000), which is incorporated herein by references for all purposes.

In some embodiments, x, the “true signal”, may be determined using the Tikhonov-regularization (two-norm penalty) method as illustrated below:

$$x = \begin{matrix}arg min \\ z \geq 0\end{matrix} {‖ y - u * z ‖}_{2}^{2} + {λ}^{2} {‖ z ‖}_{2}^{2}$$

In other embodiments, the process of deconvolution can be made using the maximum entropy (entropy penalty) method. (Donoho D. L., 1992, and Ramanation R. et al., 2004), which are incorporated herein by reference for all purposes. When using the maximum entropy method, x in the above function is determined using the method illustrated below:

$$x = \begin{matrix}arg min \\ z \geq 0\end{matrix} {‖ y - u * z ‖}_{2}^{2} - μ {\sum }_{j} {z}_{j} log ( {z}_{j} )$$

In preferred embodiments, the process of deconvolution is made by a least-square estimate with a 1-norm penalty, also known as the basis pursuit algorithm. Basis pursuit is described in Donoho, D. L. et al., 1992, which is incorporated herein by reference for all purposes. More preferably, using basis pursuit, the current invention contemplates the use of the L¹ regularized problem to solve x as illustrated below:

$$x = \begin{matrix}arg min \\ z \geq 0\end{matrix} {‖ y - u * z ‖}_{2}^{2} + λ {‖ z ‖}_{1}$$

The basis pursuit deconvolution is an optimization problem with asymptotic minimax optimality properties proven for signals where a high percent of the points are noise. A 1D-slice of a well-separated 2D signal falls in the regime of being “nearly black” in this sense.

Two major benefits of using the basis pursuit method for separating mass spectrometry peaks are as follows. First, the output is maximally sparse; second, with a carefully chosen λ, the output x is an asymptotically minimax (and hence in a measurable sense “best”) statistical estimate of the true signal in the presence of white noise. The basis pursuit method has been further described by Chen, S. S., et al., 2001, and Donoho, D. 1992, which are incorporated herein by reference for all purposes.

In preferred embodiments, deconvolution step 135 further includes using fast wavelet transforms for convolution calculations.

Deconvolution step 135 may further include one or more means for removing noise and/or increasing resolution. Poisson noise may be removed in any method known in the art. In some embodiments, poisson noise may be removed separately from the white noise by assuming that the deconvolved output is signal with only poisson noise. In some embodiments, poisson noise may be incorporated in the deconvolution model by modifying the objective function to be a penalized log-likelihood function rather than a penalized least-squares problem. Additionally, while white noise and poisson noise are independent of position, there may be correlations between white noise and poisson noise that may be detected by an operator skilled in the art. Thus, noise level may be used in an objective function calculation for deconvolution step 135. A deconvolution objective function may be modified by methods known in the art to reduce such noise.

The deconvolution step 135 may further include the use of fast fourier transform (FFT) for convolution calculations. This is possible because of a well-known mathematical relationship between Fourier transform and convolution—given two signals A and B, the FFT of the convolution C of A and B is equal to the pointwise multiplication of FFT of A with the FFT of B.

After x is obtained by deconvolution, it is retransformed or descaled in step 140 to place the output signals in their correct positions on the original time-of-flight axis. The descaling transformation for the linear peak width increase is the inverse function of the following algorithm:

$$T = ( t ( 0 ) + \frac{b}{a} ) exp ( a S ) - \frac{b}{a}$$

In some embodiments, a 1D mass spectrum may be processed without scaling step 130 and descaling step 140 using a non-scaling method. The non-scaling method is preferably a wavelet basis where the time-of-flight dependence of a blurring operator is included directly in the algorithm. A wavelet basis contemplates a method that overcomes the scaling steps by incorporating the peak width scaling information into the operator K and then using the basis pursuit algorithm optimization problem:

$$x = \begin{matrix}arg min \\ z \geq 0\end{matrix} {‖ y - K z ‖}_{2}^{2} + λ {‖ z ‖}_{1}$$

This approach requires the construction of an operator K that replaces spikes with peaks of different widths depending on where in the time-of-flight axis the spike occurs.

Both the scaling-deconvolving-descaling method and the wavelet basis operator construction method are specific implementations of the basis pursuit method.

Preferably, deconvolution algorithm yields data with increased resolution. For example, in some embodiments, deconvolution step 135 enhances the signal-to-noise ratio of the spectrum by at least 2, more preferably by at least 5, more preferably by at least 10, more preferably by at least 50, more preferably by at least 100. In some embodiments, deconvolution step 135 yields data with increased resolution by a factor of at least 1.5, more preferably by at least 2, more preferably by at least 10, more preferably by at least 100. In some embodiments, the deconvolution step results in a spectrum with less than 20% artifact peaks, more preferably less than 10%, more preferably with less than 5%, more preferably less than 1%, more preferably less than 0.1%.

Once a 1D mass spectrum has been deconvolved, the number of output peaks representing observable isotope states of ion species is 50% accurate, more preferably 60%, more preferably 70%, more preferably 80%, more preferably 90%, more preferably 95%, more preferably 99% accurate.

Furthermore, among all deconvolved peaks that represent an observable isotope state of a molecular ion species, the mass-to-charge accuracy is preferably within 1% of its true mass-to-charge, more preferably within 0.1%, more preferably within 0.001%, more preferably within 0.0001%, more preferably within 100 ppm, more preferably within 10 ppm, more preferably within 5 ppm.

Additionally, among all deconvolved peaks that represent an observable isotope state of a molecular ion species, the intensity of the deconvolved output deviates from the count or the representation of the ion count of the detected ions without noise by at most 30%, more preferably by at most 20%, more preferably by at most 10%, more preferably by at most 5%, or more preferably by at most 1%.

Once a 1D mass spectrum has been deconvolved and descaled, it may optionally be corrected by using isotope distribution data to group deconvolved peaks into isotopic clusters in step 145. For example, if a particular group of signals is known to belong to the signal for a particular molecular ion species, then a few statistics such as center of mass, total intensity, and approximate number of carbons may be estimated. Such statistics will be sufficient to determine the binomial structure of the isotope distribution, and hence the charge state and positions of the true isotope positions.

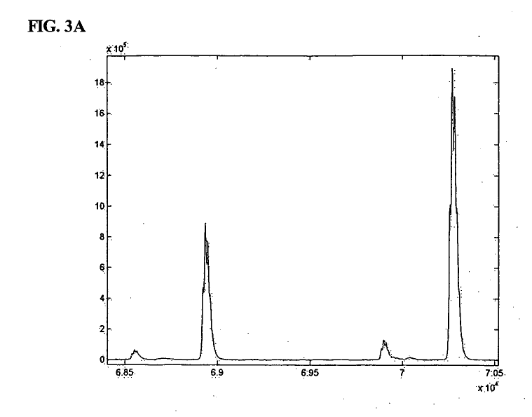

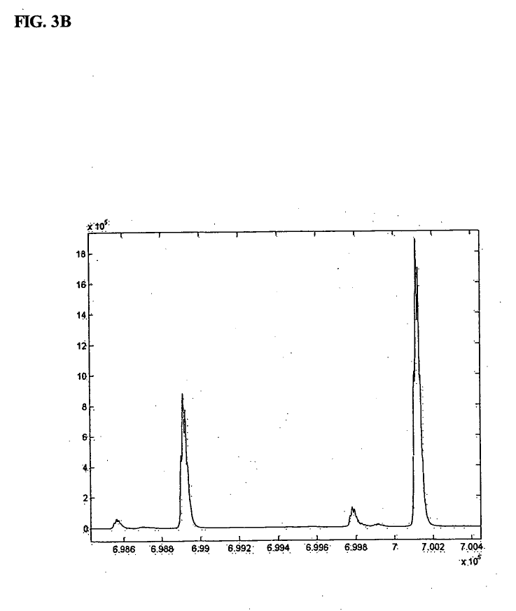

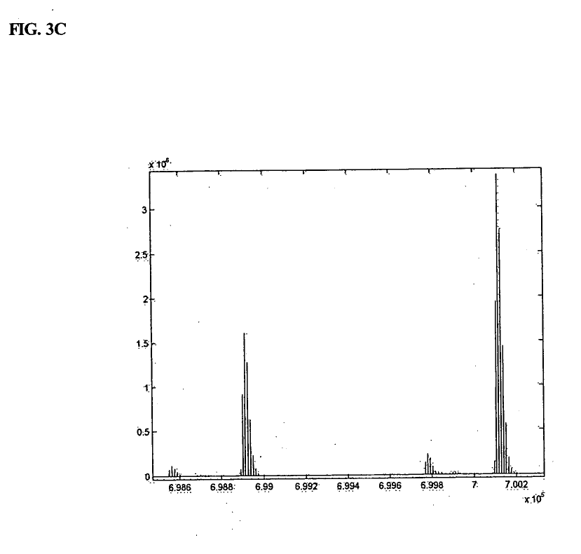

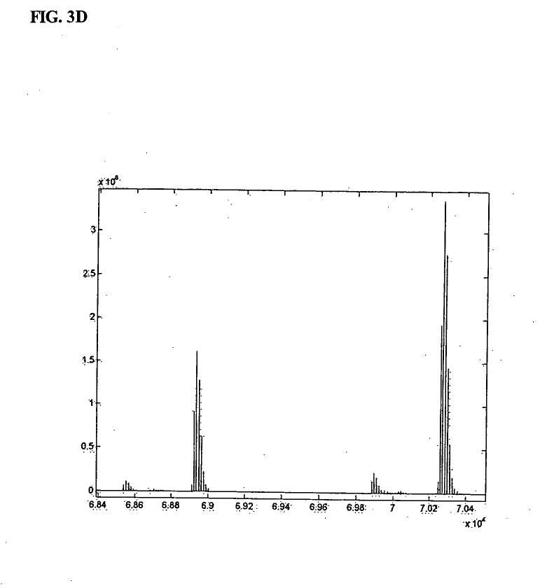

FIG. 3 illustrates the process of scaling, deconvolving, and descaling. FIG. 3A illustrates a 1D spectrum before scaling (raw data). As can be seen by this figure, each cluster comprises of multiple peaks. FIG. 3B illustrates a 1D spectrum after scaling but before deconvolution. FIG. 3C illustrates the scaled and deconvolved spectrum. FIG. 3D illustrates the scaled and deconvolved spectra after it has been descaling.

Subsequent to deconvolving 135, descaling 140, and correcting 145, a 1D mass spectrum may be converted into 2D spectrum in step 147. Preferably, data are formed into 2D by continuously ionizing a sample such that a peak of interest is detected in more than one, more than two, more than three, more than four, more than 5, or preferably more than 10 spectra. Conversion of 1D spectrum to 2D spectrum preferably involves the use of a programmable computer unit that can line up 1D spectra wherein identical m/z's line up on the x-axis and that sequential spectra line up on the y-axis.

FIG. 4 illustrates the process of compiling multiple 1D spectra into a 2D spectrum. FIG. 4A illustrates the compilation of multiple 1D spectra such that similarly situated peaks are aligned vertically. Peaks 1, 2, 3, and 4 are exemplary peaks that align in more than 1, 2, or 3 sequential mass spectra. FIG. 4B illustrates a compiled 2D spectrum of more than 20 individual 1D spectra.

After conversion of 1D spectrum into 2D spectrum in step 147, the 2D spectrum is subject to cluster analysis and collapsing of 2D peaks in step 150. Cluster analysis 150 allows for the determination of 2D peaks in order to allow each isotope/charge state combination for a molecular ion species to be represented only once in the resulting data. There are numerous forms of 2D clustering analysis methods. Any clustering analysis method known in the art may be used for 2D clustering analysis. Such methods include, for example, Anderberg, 1973; Hartigan, 1975; Jain and Dubes, 1988; Jardine and Sibson, 1971; Sneath and Sokal, 1973; Tryon and Bailey, 1973; MacQueen 1967; Gersho, 1979, Gray, 1984, Makhoul et al., 1985, all of which are incorporated herein by reference for all purposes.

In some embodiments, step 150 isotopic peak clusters may be identified by statistical estimation of a model defined by the physical properties of the isotopic variation for a charge state of a species. Specifically, isotopic clusters are expected to have spacing between peaks approximately equal to the inverse of the number of charges (charge state) for that cluster. Relative intensities of peaks within an isotopic cluster are expected to be identified approximately by a probability distribution such as a binomial distribution for the number of heavy carbon isotopes in the isotopic mass creating each peak in the isotopic cluster. Actual intensities may further vary by noise in m/z location and/or intensity according to poisson or other statistical models. These physically derived statistical relationships of peak spacing and relative intensity within an isotope cluster define a model with parameters that can be estimated by standard methodology such as maximum likelihood or least squares methods.

Parameters to be estimated could include various combinations of: m/z location of the maximum intensity peak (or a reference peak for the cluster); parameters of the binomial or other statistical model describing relative peak intensities; overall intensity of the cluster (e.g. absolute intensity of the maximum-intensity peak); charge state (z) or inverse charge state (1/z) giving peak spacing; and parameters of distributions describing noise in m/z location and/or peak intensity. In some cases particular parameters can be estimated from a subset of data and used for the remainder of the data.

The 2D clustering analysis of step 150 usually involves the use of one or more parameters having a minimum or maximum threshold. The thresholds allow for a programmable machine or a person to make a binary decision—whether a peak belongs to a cluster or not. If a peak belongs to a cluster, then the peak is further analyzed as described below. If a peak does not belong to a cluster, then it may be removed from further analysis or subject to further analysis as described below.

Examples of parameters that have minimum or maximum thresholds that may be used for 2D clustering analysis in deciding if a peak belongs to a particular cluster include, but are not limited to, noise level, signal-to-noise ratio, spacing between peaks, and atomic mass unit differences.

For example, in some embodiments, a peak can be included in an envelope if it is located less than a multiple of 1, 2, 4, or 8 of the peak's width away from the envelope (or another peak). Using the above example, all peaks located further than an above threshold distance are not deemed part of the envelope, while all peaks located within an above threshold distance are deemed to be part of an envelope.

In some embodiments, a parameter for clustering may be noise level, a threshold amount for identifying resolved peaks may be any peak with intensity above a particular noise level or a multiple of that noise level, e.g., 1, 20, 40, or 80 times a particular noise level. Using such a threshold, all peaks below a threshold are eliminated from further calculations, while all peaks above the threshold are further analyzed. By setting a threshold parameter (e.g., noise level) below of which a deconvolved signal is not considered a peak, and retaining only deconvolved signals above a certain threshold, the original dataset may be reduced in size by at least 1 order of magnitude, at least 2, at least 3, or at least 4 orders of magnitude.

In some embodiments, the parameter for identifying resolved peaks might be the difference in atomic mass unit between two peaks. If a second peak has an atomic mass unit that is greater than a particular threshold, e.g. >1 m/z, than that second peak is deemed outside of a particular cluster. If, on the other hand, a second peak has mass that is less than a particular threshold, than it is deemed to belong to the cluster of the first peak and is further analyzed as described below. The parameter used to cluster isotope states may be determined empirically without reference to m/z differences.

Other parameters and numerical values for such parameters may also be used, independently or in conjunction with any of the above. Parameters and their numerical values may be determined depending upon the sample, mass spectrometer, and the 2D spectrum output. The selection of parameters and their numerical values is generally known to a person or ordinary skill in the art.

Typically, the order of magnitude of raw separations-mass spectra is several orders of magnitude larger than the number of molecular ion species detected from the sample. After 2D cluster analysis, the 2D mass spectrum data may be converted into a list of 2D peaks step 150. The conversion involves grouping peaks across 1D spectra that occur at the same or similar m/z's and representing that group of peaks by a single intensity value for the cluster. The 2D peaks represent an intensity contribution for the collective isotope states of each ion species.

Once a 2D peak list is generated, each 2D peak is de-isotoped in step 160. De-isotoping is the process of summing up the contributions of all of the isotope state intensities and placing the sum either at the m/z position of the molecular ion species where only carbon-12 occurs or at the centroid of the molecular ion species, where centroid is defined as the m/z position of the intensity weighted average over all observable isotopes. The sum of all of the isotope state intensities for one cluster is also referred to as the “total intensity” of the cluster. Deisotoping is performed by any known method.

For example, in one embodiment, deisotoping is performed for a cluster comprising of 1D deconvolved peaks that represent isotopes of a molecular ion species within an accuracy of 0.1 m/z by summing up intensities and placing them at the position of the m/z of determined monoisotopic m/z.

In some embodiments, deisotoping is performed for a cluster comprising of 1D deconvolved peaks that may or may not represent accurate molecular ion species within an accuracy of 0.1 m/z, by estimating an average m/z position by an intensity-weighted average of the peaks, and placing the sum of the intensities at that m/z position.

After deisotoping of step 160 has been competed, the deisotoped peaks are de-charged in step 165. De-charging is the process of determining the clusters that represent the different charge states of the same molecular species, calculating the molecular weight and/or the average molecular weight of the molecular species, and placing the sum of the intensities of each charge state of the molecular species at the determined molecular weight. In other words, decharging involves collapsing neutral mass components. De-charging is performed by any known method.

In one embodiment, a cluster whose underlying deconvolved 1D peaks represent the molecular ion species isotope state within an accuracy of 0.1 m/z, may be decharged by determining the spacing between it and other 1D deconvolved peaks.

In one embodiment, a cluster whose underlying deconvolved 1D peaks may or may not represent the molecular ion species isotope states within an accuracy of 0.1 m/z, may be de-charged by determining by the width of the lineshape and the width of the collection of peaks at half max. Not sure what the algorithm is here.

In one embodiment, charge state is assigned by maximizing a score that is a function of charge state and intensities that increases with the intensities of contiguous charge states also present.

In one embodiment, the likelihood of the presence of a given neutral mass component is calculated by making a table of possible neutral mass on x-axis, possible charge states on the y-axis, and putting a score for each entry. In a second step, analysis of this table is performed to determine the highest likelihood of particular molecular weights present in the spectrum. Additional methods to calculate likelihood of presence of a given neutral mass component include those disclosed in Trevor Hastie, Robert Tibshirani, and Jerome Friedman, The Elements of Statistical Learning: Data Mining, Inference, and Prediction. Springer, 2001; and Ludwig Fahrmeir and Gerhard Tutz, Multivariate Statistical Modelling Based on Generalized Linear Models. Springer, 1994, both of which are incorporated herein by reference in their entirety for all purposes.

In addition, for example, if the charge distribution of a species is independent of its m/z, then we can cast the de-charging problem as a singular matrix inversion problem. More precisely, suppose there are N possible neutral masses {m₁, . . . , m_{N}}, and the possible charges by electrospray are {i₁, . . . , i_{K}), and the coefficients of these charges are {a₁, . . . , a_{K}), where aᵢ>0 and aᵢ+ . . . +a_{K}=1. Then the charging operator G on a neutral mass intensity I at mₚ is given by the sum of a_{—k}I at m/z=mₚ/iₖ+e. This operator is not necessarily invertible, and therefore we propose the use of an L (L1?) penalty to find an approximate inverse.

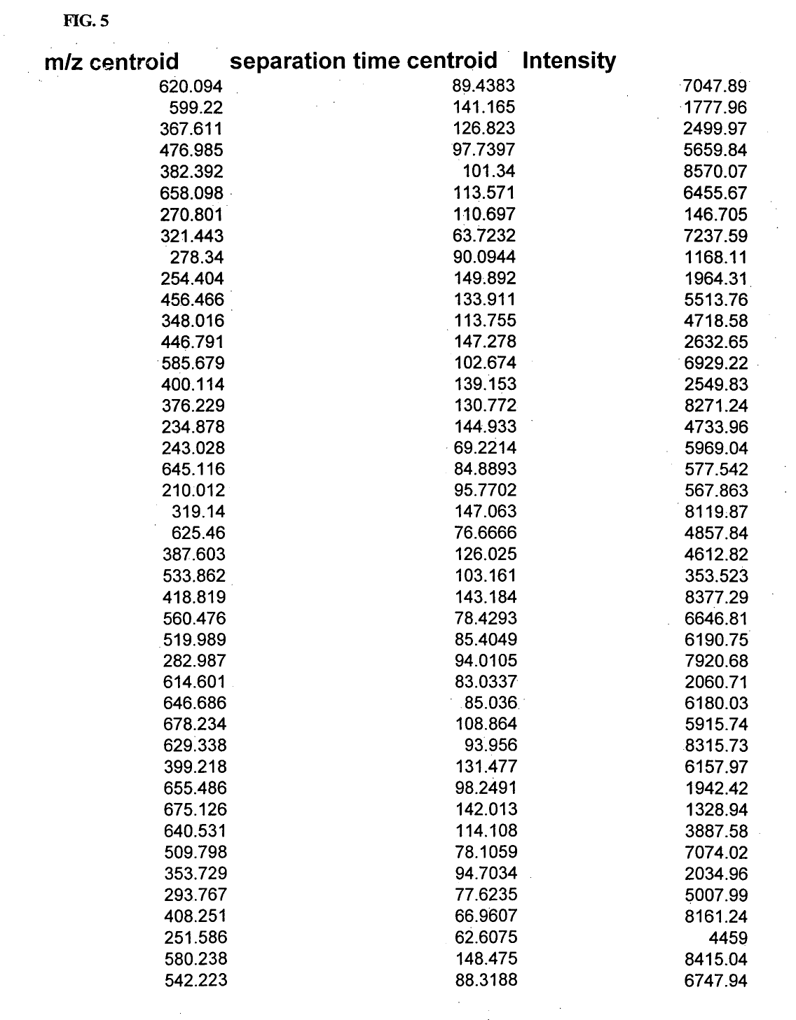

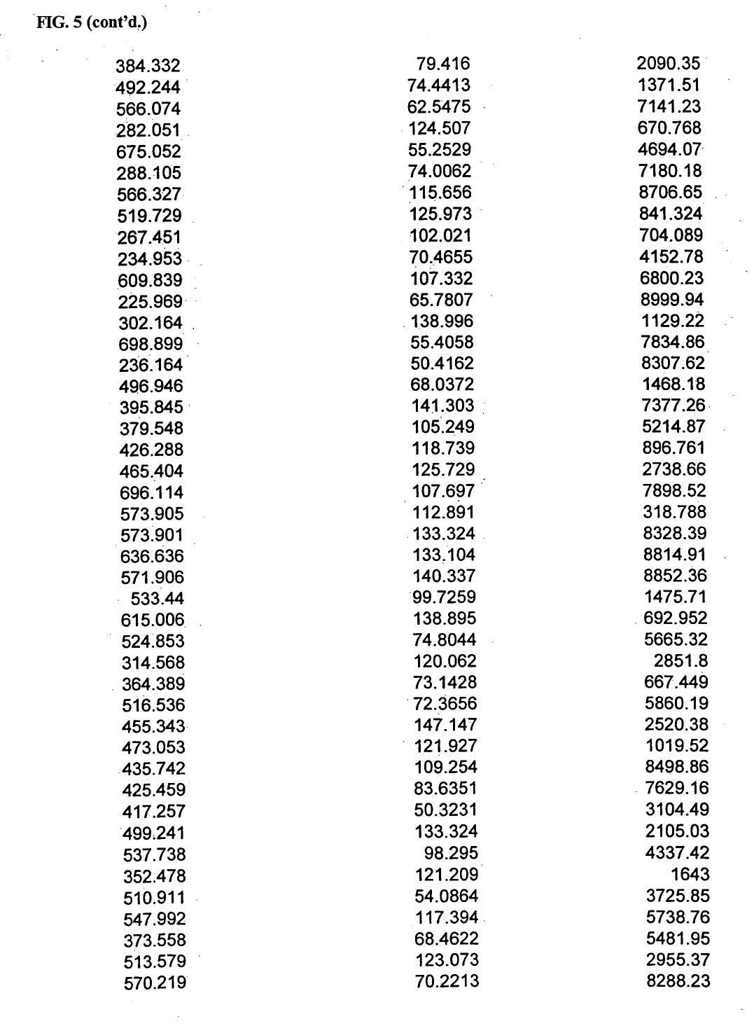

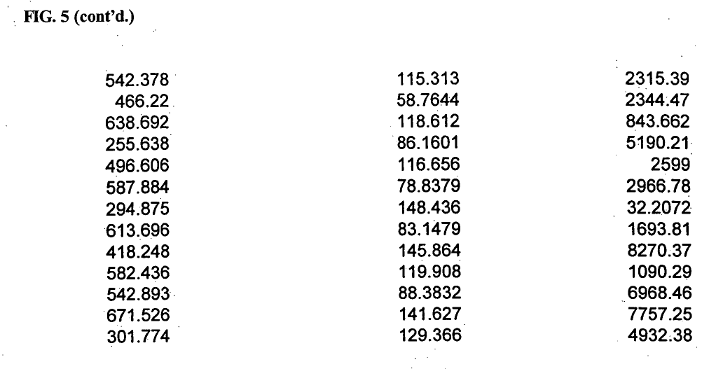

Neutral mass data is compiled into a list, as is illustrated by FIG. 5. FIG. 5 illustrates a list of data output that may be generated by the methods herein. FIG. 5, Column 1, illustrates neutral mass values; FIG. 5, Column 2, illustrates the centroids in separation time value; and FIG. 5, Column 3, illustrates the title intensity under island of delta neutrals.

The present invention further contemplates alignment of multiple neutral mass lists or multiple 2D peak lists. Alignment can be done using a programmable computer unit. Alignment of spectra in the separation time axis can be accomplished by estimating a linear or non-linear relationship between the separation times of particular peaks between any two samples. Peaks used for estimation of the alignment relationship can include known calibrants or known endogenous peaks that are consistently present. The separation time of known peaks (calibrants or endogenous) is estimated for each sample. A reference set of separation times for each known peak is either estimated as the average separation time, or is fixed at known reference values, or is chosen to be the separation times for a particular sample, or is chosen or estimated by some other method. The relationship between separation times of the known peaks of each sample and the reference locations of those peaks is estimated using methods for statistical function estimation, such as linear regression, piecewise linear regression, non-linear regression such as polynomial regression or piecewise or local polynomial regression, or other function estimation methods. Once the relationship is estimated; it is used to adjust separation times for the non-reference spectra to match those of the reference spectra. This method has been described assuming known peaks (calibrants or endogenous) are available. We also include in this methodology estimation of those peaks from the data.

This data may be used to find patterns in data from many samples by using statistical or pattern recognition methods. Alternatively, if one already has knowledge of a pattern of interest, this data may be used to assess the presence or absence of that pattern in a dataset.

The methods herein are particularly useful for the diagnosis of disease. In some embodiments, a mammal is diagnosed as having (or not having) a disease state by testing a sample from said mammal for the presence (or absence) of a particular 2D peak or neutral mass. For example, a mammal may be tested for a disease state wherein the disease is selected from the group consisting of a neoplastic disease, an immunologic disease, an endocrine disease, a metabolic disease, or a cardiovascular disease. More preferably, the disease state is a neoplastic disease. Neoplastic diseases include, but are not limited to, any condition associated with excessive cellular proliferation, such as brain cancer, breast cancer, bone cancer, cancer of the larynx, gallbladder, pancreas, rectum, parathyroid, thyroid, adrenal, neural tissue, head and neck, colon, stomach, bronchi, kidneys, basal cell carcinoma, squamous cell carcinoma of both ulcerating and papillary type, metastatic skin carcinoma, osteo sarcoma, Ewing's sarcoma, veticulum cell sarcoma, myeloma, giant cell tumor, small-cell lung tumor, gallstones, islet cell tumor, primary brain tumor, acute and chronic lymphocytic and granulocytic tumors, hairy-cell tumor, adenoma, hyperplasia, medullary carcinoma, pheochromocytoma, mucosal neuronms, intestinal ganglloneuromas, hyperplastic corneal nerve tumor, marfanoid habitus tumor, Wilm's tumor, seminoma, ovarian tumor, leiomyomater tumor, cervical dysplasia and in situ carcinoma, neuroblastoma, retinoblastoma, soft tissue sarcoma, malignant carcinoid, topical skin lesion, mycosis fungoide, rhabdomyosarcoma, Kaposi's sarcoma, osteogenic and other sarcoma, malignant hypercalcemia, renal cell tumor, polycythermia vera, adenocarcinoma, glioblastoma multiforma, leukemias, lymphomas, malignant melanomas, skin cancer, leukemia, prostate cancer, liver cancer, lung cancer, and epidermoid carcinomas.

A solid or liquid sample or biopsy is obtained from the mammal. Examples of liquid samples include urine, nasal discharge, vaginal discharge, mucus, lymph, blood, serum, plasma, saliva, and tears. In preferred embodiment, a liquid sample such as serum is used. The sample is then acidified. This denatures proteins in the sample. The sample is then separated to eliminate certain size molecules from the sample. The sample is then provided into a mass spectrum where the sample is ionized, preferably by an electrospray or nano-electrospray. After ionization, a mass analyzer is used to separate ions according to size and charge. The 1D mass spectrum produced by the mass analyzer is provided to a computer system for analysis as described herein.

This invention also relates to high throughput automated system for determining composition(s) in sample(s) and abundance of such composition(s). Patterns of sample compositions can subsequently be used for diagnosis, prognosis, and as research tools.

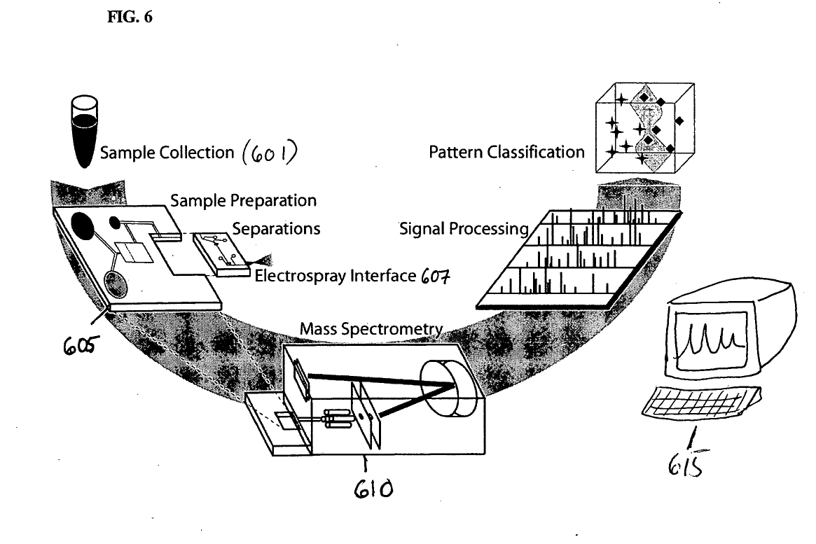

FIG. 6 illustrates an overview of the high throughput automated system. In step 601 one or more samples are collected. For example, samples can be collected from control and case individuals in conducting association studies. The samples are then loaded onto an apparatus that includes a preparation/separation unit 605 and a mass spectrometer unit 610. The preparation/separation unit 605 is preferably a microfluidic chip that can perform sample preparation (e.g., acidification) and separation (e.g., electrophoresis). The preparation/separation unit 605 and the mass spectrometer unit 610 are coupled for high-throughput screening. In preferred embodiments, the fluidic device preparation/separation unit 605 has an electrospray interface 607. The mass spectrometer unit 610 and, optionally, the preparation/separation unit 605 are connected online via an interface to a computer unit 615. The computer unit 615 can include a program to control sample preparation, sample separation, ionization, and mass analysis. The computer unit 615 preferable includes means for storage of measured values and data. The computer unit 615 can also function to compare the new measured values with previous measured values already stored. The computer is connected to the other units online and has an interface system as is illustrated in FIG. 6.

In preferred embodiments, the separation device is a capillary electrophoresis device. In other preferred embodiments, the separation device is a microfluidics chip. A separation device preferably has high separation efficiency, permitting high-resolutions separations in less than 24 hours, less than 2 hours, less than 30 minutes, more preferably less than 15 minutes, more preferably less than 10 minutes.

The mass spectrometer device and computer device provide prompt information regarding a given sample (e.g., quality and quantity), and can be used for quick diagnosis, prognosis and analysis. For example, markers for early stages of a disease or for genetic disposition may be identified using the methods and devices herein. Such markers can then be used for diagnosis and prognosis of disease. In preferred embodiments, a sample may be analyzed in less than 15 minutes, more preferably less than 10 minutes, or more preferably less than 5 minutes.

1. A method comprising:
generating a mass spectrum;
providing a lineshape for said mass spectrum; and
deconvolving said mass spectrum with said lineshape.

2. The method of claim 1 wherein said mass spectrum is a 2D separation-mass spectrum.

3. The method of claim 1 wherein said mass spectrum is a mass-to-charge ratio mass spectrum.

4. The method of claim 1 wherein said generating step involves the use of a mass spectrometer.

5. The method of claim 4 wherein said mass spectrometer is a time-of-flight mass spectrometer or a fourier transform ion cyclotron mass spectrometer.

6. The method of claim 5 wherein said mass spectrometer is a time-of-flight mass spectrometer.

7. The method of claim 4 wherein the mass spectrometer collects tandem mass spectrometry data.

8. The method of claim 4 wherein said mass spectrometer comprises an ion source selected from the group consisting of: an ESI, a nano-ESI, atmospheric pressure chemical ionization, matrix-assisted laser desorption ionization, surface-enhanced laser desorption ionization, desorption ionization on silicon, fast atom/ion bombardment, electron ionization, and chemical ionization.

9. The method of claim 8 wherein said ion source is an ESI.

10. The method of claim 4 wherein said mass spectrometer is coupled to a separation device.

11. The method of claim 1 further comprising a step of separating a sample prior to generating said mass spectrum.

12. The method of claim 11 wherein said separating is preformed by electrophoresis or high performance liquid chromatography.

13. The method of claim 11 wherein said separating is performed by microfluidic chip.

14. The method of claim 11 wherein said separating device separates a composition having a molecular weight selected from the group consisting of less than 2 kDa, less than 30 kDa, less than 50 kDa, 50 Da-150 kDa, and more than 150 kDA.

15. The method of claim 11 wherein said lineshape is determined based upon at least one physical parameter of the separating step or the generating mass spectrum step.

16. The method of claim 1 wherein said lineshape is determined from raw data.

17. The method of claim 1 further comprising the step of estimating one or more parameters that determine said lineshape.

18. The method of claim 6 further comprising the step of scaling said lineshape as a function of time-of-flight.

19. The method of claim 6 wherein said lineshape varies deterministically along a time-of-flight axis.

20. The method of claim 19 wherein the width of the lineshape varies linearly or quadratically as a function of time-of-flight.

21. The method of claim 20 wherein the linear or quadratic parameters are calculated from data using a parametric model of lineshape.

22. The method of claim 21 wherein said parametric model of lineshape is determined using a model of said lineshape that comprises initial position and energy distribution of ions.

23. The method of claim 21 wherein said parametric model of lineshape is gaussian.

24. The method of claim 21 wherein said parametric model of lineshape is student-t distribution.

25. The method of claim 21 wherein said parametric model of lineshape is determined by computer simulation of said mass spectrometer.

26. The method of claim 1 wherein said deconvolving step comprises an algorithm selected from the group consisting of basis pursuit (one-norm penalty), Tikhonov regularization (two-norm penalty), maximum entropy (entropy penalty), and parametric deconvolution.

27. The method of claim 1 wherein said deconvolving step involves the use of basis pursuit algorithm.

28. The method of claim 1 wherein said deconvolving step further comprises estimating noise level.

29. The method of claim 28 wherein said noise level is used in an objective function calculation for said deconvolving step.

30. The method of claim 1 wherein said deconvolving step further comprises use of fast wavelet transform for convolution calculation.

31. The method of claim 1 wherein the said deconvolving step yields data with increased resolution.

32. The method of claim 31 wherein said resolution is increased by at least 1.5.

33. The method of claim 1 wherein the said deconvolving step reduces noise.

34. The method of claim 33 wherein said deconvolving step reduces noise by modifying the objective function to be a penalized log-likelihood function rather than a penalized least-squares problem.

35. The method of claim 1 wherein the said deconvolving step increases signal-to-noise ratio.

36. The method of claim 35 wherein said signal-to-noise ratio is increased by at least 2, 5, 10,or 50.

37. The method of claim 1 further comprising the step of correcting deconvolved spectrum using isotope distribution data to group deconvolved peaks into isotopic clusters.

38. The method of claim 37 wherein said isotope data is modeled as a binomial distribution with parameters N and p, where N is the approximate number of carbons and p is the probability of occurrence of carbon-13 isotope.

39. The method of claim 38 wherein the approximate number of carbons is estimated by regression of number of carbons from a set of known peptides.

40. The method of claim 38 wherein the probability of occurrence of carbon-13 in proteins and peptides in sample is estimated from data.

41. The method of claim 37 wherein said isotope distribution data and the lineshape are used to calculate a charge state of an envelope.

42. The method of claim 1 further comprising the step of descaling deconvolving mass spectrum.

43. The method of claim 1 further comprising the step of converting 1D mass spectrum to 2D mass spectrum.

44. The method of claim 43 further comprising the step of conducting 2D cluster analysis to determine centroid location for each envelope.

45. The method of claim 1 further comprising the step of calculating a charge state for an envelope.

46. The method of claim 45 wherein the charge state is calculated using the width of the lineshape and the width of an unresolved enveloped peak in the raw spectrum.

47. The method of claim 45 wherein the charge state is calculated using the width of the lineshape and the width of a deconvolved envelope with the lineshape.

48. The method of claim 45 wherein the charge state is calculated using the spacing between peaks in a corrected deconvolved output within a cluster.

49. The method of claim 1 further comprising the step of creating a list of 2D peaks in the spectrum by their positions and total intensities.

50. The method of claim 1 further comprising the step of creating a list of neutral mass components by their migration times and total intensities.

51. The method of claim 1 further comprising the step of aligning a plurality of lists of neutral masses from multiple 2D mass spectra or a plurality of lists of 2D peaks from multiple 2D mass spectra, wherein said lists provide location and total intensity for each neutral mass or 2D peak.

52. The method of claim 51 wherein the list of 2D peaks is collapsed to a neutral mass component list.

53. A method comprising:
creating a list of 2D peaks derived from a deconvolved mass spectrum; and
aligning a plurality of such lists.

54. A method comprising
creating a list of neutral mass components derived from a mass spectrum; and
aligning a plurality of such lists.

55. A method for diagnosing a mammal comprising the steps of:
obtaining a sample from said mammal;
analyzing the sample with a device that performs separation and mass spectrometry;
determining a list of 2D peaks derived from said separation and mass spectrometry; and
identifying the existence or lack of existence of a 2D peak or a pattern of 2D peaks.

56. A method for diagnosing a mammal comprising the steps of:
obtaining a sample from said mammal;
analyzing the sample with a device that performs separation and mass spectrometry;
determining a list of neutral mass components in said sample; and
identifying the existence or lack of existence of a neutral mass component or a pattern.

57. A method for diagnosing a disease state in a mammal comprising the steps of:
obtaining a sample from said mammal;
performing separations on the said sample;
generating a mass spectrum from said sample;
providing a lineshape for said spectrum; and
deconvolving said spectrum with said lineshape.

58. The method of claim 57 wherein said mass spectrum is a 2D mass spectrum.

59. The method of claim 57 wherein said sample is a liquid sample selected from the group consisting of urine, nasal discharge, vaginal discharge, mucus, lymph, blood, serum, plasma, saliva, and tears.

60. The method of claim 57 wherein said generating step involves the use of a mass spectrometer.

61. The method of claim 60 wherein said mass spectrometer is selected from the group consisting of a time-of-flight mass spectrometer, a time-of-flight reflectron mass spectrometer, a Quad time-of-flight mass spectrometer, and a Fourier transform ion cyclotron mass spectrometer.

62. The method of claim 60 wherein said mass spectrometer is a time-of-flight mass spectrometer.

63. The method of claim 60 wherein the mass spectrometer collects tandem mass spectrometry data.

64. The method of claim 60 wherein said mass spectrometer comprises an ion source selected from the group consisting of: an ESI, a nano-ESI, atmospheric pressure chemical ionization, matrix-assisted laser desorption ionization, surface-enhanced laser desorption ionization, desorption ionization on silicon, fast atom/ion bombardment, electron ionization, and chemical ionization.

65. The method of claim 64 wherein said ion source is an ESI.

66. The method of claim 62 wherein said mass spectrometer is coupled to a separation device.

67. The method of claim 66 wherein said separation device performs electrophoresis or high performance liquid chromatography.

68. The method of claim 67 wherein said separation device performs electrophoresis.

69. The method of claim 66 wherein said separation device is a microfluidic chip.

70. The method of claim 59 wherein said lineshape is determined based on at least one physical parameter of a separation-mass spectrometer device.

71. The method of claim 59 wherein said lineshape is determined from raw data.

72. The method of claim 59 further comprising the step of estimating one or more parameters that determine said lineshape.

73. The method of claim 59 further comprising the step of scaling said lineshape along a time-of-flight axis.

74. The method of claim 59 wherein said lineshape varies deterministically along a time-of-flight axis.

75. The method of claim 59 wherein width of the lineshape varies according to a linear parameter or a quadratic parameter as a function of time-of-flight.

76. The method of claim 75 wherein the linear or quadratic parameter is calculated from data using a parametric model of lineshape.

77. The method of claim 76 wherein said parametric model of lineshape is determined using a model of said lineshape that comprises initial position and energy distribution of ions.

78. The method of claim 76 wherein said parametric model of lineshape is gaussian.

79. The method of claim 76 wherein said parametric model of lineshape is Student-t distribution.

80. The method of claim 76 wherein said parametric model of lineshape is determined by computer simulation of said mass spectrometer.

81. The method of claim 59 wherein said deconvolving step comprises using an algorithm selected from the group consisting of basis pursuit (one-norm penalty), Tikhonov regularization (two-norm penalty), maximum entropy (entropy penalty), and parametric deconvolution.

82. The method of claim 59 wherein said deconvolving step comprises using basis pursuit algorithm.

83. The method of claim 59 wherein said deconvolving step further comprises estimating noise level.

84. The method of claim 83 wherein said noise level is used in an objective function calculation for said deconvolving step.

85. The method of claim 59 wherein said deconvolving step further comprises of the use of fast wavelet transform for convolution calculation.

86. The method of claim 59 wherein the said deconvolving step yields data with increased resolution.

87. The method of claim 86 wherein said resolution is increased by at least 1.5.

88. The method of claim 59 wherein the said deconvolving step reduces noise.

89. The method of claim 88 wherein said deconvolving step reduces noise by modifying the objective function to be a penalized log-likelihood function rather than a penalized least-squares problem.

90. The method of claim 59 wherein the said deconvolving step increases signal-to-noise ratio.

91. The method of claim 90 wherein said signal-to-noise ratio is increased by at least 2, 5, 10, or 50.

92. The method of claim 59 wherein deconvolved spectrum is corrected by using isotope distribution data to group deconvolved peaks into isotopic clusters.

93. The method of claim 92 wherein said isotope data is modeled as a binomial distribution with parameters N and p, where N is the approximate number of carbons and p is the probability of occurrence of carbon-13 isotope.

94. The method of claim 93 wherein the approximate number of carbons is estimated by regression of number of carbons from a set of known peptides.

95. The method of claim 93 wherein the probability of occurrence of carbon-13 is estimated from the spectrum.

96. The method of claim 92 wherein said isotope distribution data and the lineshape are used to calculate a charge state of an envelope.

97. The method of claim 59 wherein deconvolved spectrum resulting from said deconvolving step is descaled.

98. The method of claim 59 further comprising the step of descaling output from said deconvolving step.

99. The method of claim 92 wherein corrected deconvolved spectra are submitted to a 2D cluster analysis to determine centroid location for each envelope.

100. The method of claim 59 further comprising the step of conducting 2D cluster analysis to determine centroid location for each envelope.

101. The method of claim 59 further comprising the step of calculating for each peak one or more data points selected from the group consisting of: mass-to-charge, mass, monoisotopic abundance, total abundance, migration time centroid, charge state, and migration time width.

102. The method of claim 101 wherein the charge state is calculated using the width of the lineshape and the width of the unresolved enveloped peak in the raw spectrum.

103. The method of claim 101 wherein the charge state is calculated using the width of the lineshape and the width of the deconvolved envelope with the lineshape.

104. The method of claim 101 wherein the charge state is calculated using the spacing between the peaks in a corrected deconvolved output within a cluster.

105. The method of claim 59 further comprising the step of creating a list of 2D peaks in the spectrum by their positions and total intensities.

106. The method of claim 59 further comprising the step of creating a list of neutral mass components by their migration times and total intensities.

107. The method of claim 59 further comprising the step of aligning a plurality of lists of neutral masses from multiple 2D mass spectra or a plurality of lists of 2D peaks from multiple 2D mass spectra, wherein said lists provide location and total intensity for each neutral mass or 2D peak.

108. The method of claim 107 wherein the list of 2D peaks is collapsed to a neutral mass component list.

109. The method of claim 108 wherein the presence or absence of a neutral mass or a 2D peak is indicative of a disease state.

110. The method of claim 108 wherein the presence or absence of a pattern of neutral mass or 2D peaks is indicative of disease state.

111. The method of claim 59 wherein the disease state is selected from the group consisting of a neoplastic disease, an immunologic disease, an endocrine disease, a metabolic disease, or a cardiovascular disease.

112. The method of claim 111 wherein the disease state is a neoplastic disease.

113. The method of claim 112 wherein the neoplastic disease is selected from the group consisting of: brain cancer, breast cancer, bone cancer, cancer of the larynx, gallbladder, pancreas, rectum, parathyroid, thyroid, adrenal, neural tissue, head and neck, colon, stomach, bronchi, kidneys, basal cell carcinoma, squamous cell carcinoma of both ulcerating and papillary type, metastatic skin carcinoma, osteo sarcoma, Ewing's sarcoma, veticulum cell sarcoma, myeloma, giant cell tumor, small-cell lung tumor, gallstones, islet cell tumor, primary brain tumor, acute and chronic lymphocytic and granulocytic tumors, hairy-cell tumor, adenoma, hyperplasia, medullary carcinoma, pheochromocytoma, mucosal neuronms, intestinal ganglloneuromas, hyperplastic corneal nerve tumor, marfanoid habitus tumor, Wilm's tumor, seminoma, ovarian tumor, leiomyomater tumor, cervical dysplasia and in situ carcinoma, neuroblastoma, retinoblastoma, soft tissue sarcoma, malignant carcinoid, topical skin lesion, mycosis fungoide, rhabdomyosarcoma, Kaposi's sarcoma, osteogenic and other sarcoma, malignant hypercalcemia, renal cell tumor, polycythermia vera, adenocarcinoma, glioblastoma multiforma, leukemias, lymphomas, malignant melanomas, skin cancer, leukemia, prostate cancer, liver cancer, lung cancer, and epidermoid carcinomas.

114. The method of claim 59 wherein said mammal is a human.

115. The method of claim 59 further comprising a step of adding acid to the sample that will denature a protein in the sample.

116. The method of claim 59 further comprising a step of filtering the sample.

117. The method of claim 116 wherein said filtering step eliminates from analysis compositions greater than 30 kDa.

118. The method of claim 117 further comprising a step of concentrating said filtrate with a reverse phase column.

119. An apparatus comprising
a separation unit;
a mass spectrometer; and
a computer system, wherein said computer system can perform the functions of:
providing a lineshape for a mass spectrum; and
deconvolving said mass spectrum with said lineshape.

120. The apparatus of claim 119 wherein said separation unit performs electrophoresis or high performance liquid chromatography.

121. The apparatus of claim 119 wherein said separation unit is a microfluidic chip.

122. The apparatus of claim 121 wherein said mass spectrometer is selected from the group consisting of a time-of-flight mass spectrometer, a time-of-flight reflectron mass spectrometer, a Quad time-of-flight mass spectrometer, and a Fourier transform ion cyclotron mass spectrometer.

123. The method of claim 119 wherein said mass spectrometer is a time-of-flight mass spectrometer.

124. The method of claim 119 wherein the mass spectrometer collects tandem mass spectrometry data.

125. The method of claim 123 wherein said mass spectrometer comprises an ion source selected from the group consisting of: an ESI, a nano-ESI, atmospheric pressure chemical ionization, matrix-assisted laser desorption ionization, desorption ionization on silicon, fast atom/ion bombardment, electron ionization, and chemical ionization.

126. The method of claim 125 wherein said ion source is an ESI or a nano-ESI.

127. The method of claim 123 wherein said separation unit and said mass spectrometer are connected online.

128. The method of claim 123 wherein said computer system further performs the steps of scaling and descaling a mass spectra.

129. The method of claim 123 wherein said lineshape is determined based on at least one physical parameter of the separation unit or the mass spectrometer.

130. The method of claim 123 wherein said lineshape is determined based on raw data.

131. The method of claim 123 further comprising the step of estimating one or more parameters that determine said lineshape.

132. The method of claim 127 wherein said computer unit further performs the function of scaling said lineshape along a time-of-flight axis.

133. The method of claim 127 wherein said lineshape varies deterministically along a time-of-flight axis.

134. The method of claim 119 wherein the width of the lineshape varies according to a linear or a quadratic parametric as a function of time-of-flight.

135. The method of claim 134 wherein the linear or quadratic parameter is calculated from data using a parametric model of lineshape.

136. The method of claim 135 wherein said parametric model of lineshape is determined using a model of said lineshape that comprises initial position and energy distribution of ions.

137. The method of claim 135 wherein said parametric model of lineshape is gaussian.

138. The method of claim 135 wherein said parametric model of lineshape is Student-t distribution.

139. The method of claim 135 wherein said parametric model of lineshape is determined by computer simulation of said mass spectrometer.

140. The method of claim 119 wherein said computer deconvolves using an algorithm selected from the group consisting of basis pursuit (one-norm penalty), Tikhonov regularization (two-norm penalty), maximum entropy (entropy penalty), and parametric deconvolution.

141. The method of claim 119 wherein said computer deconvolving using basis pursuit algorithm.

142. The method of claim 119 wherein said deconvolving further comprises estimating noise level.

143. The method of claim 142 wherein said noise level is used in an objective function calculation for said deconvolving step.

144. The method of claim 119 wherein said deconvolving further comprises of the use of fast wavelet transform for convolution calculation.

145. The method of claim 119 wherein the said deconvolution step yields data with increased resolution.

146. The method of claim 145 wherein said resolution is increased by at least 1.5.

147. The method of claim 119 wherein the said deconvolving step reduces noise.

148. The method of claim 147 wherein the post-deconvolution mass spectrum has peak intensities that deviate from true area under the raw noiseless peak by at most 30%.

149. The method of claim 119 wherein the said deconvolution algorithm increases signal-to-noise ratio.

150. The method of claim 149 wherein said signal-to-noise ratio is increased by at least 2, 5, 10, or 50.

151. The method of claim 119 wherein said computer unit further corrects deconvolved spectrum using isotope distribution data.

152. The method of claim 151 wherein said isotope data is modeled as a binomial distribution with parameters N and p, where N is the approximate number of carbons and p is the probability of occurrence of carbon-13 isotope.

153. The method of claim 152 wherein the approximate number of carbons is estimated by regression of number of carbons from a set of known peptides.

154. The method of claim 152 wherein the probability of occurrence of carbon-13 is estimated from the spectrum.

155. The method of claim 151 wherein said isotope distribution data and the lineshape are used to calculate a charge state of an envelope.

156. The method of claim 119 wherein said computer system further performs the function of descaling output from said deconvolving step.

157. The method of claim 151 wherein said computer system further performs 2D cluster analysis on said corrected deconvolved spectra to determine centroid location for each envelope.

158. The method of claim 119 wherein said computer system further performs the step of calculating for each peak its mass-to-charge, mass, monoisotopic abundance, total abundance, migration time centroid, charge state, or migration time width.

159. The method of claim 158 wherein the charge state is calculated using the width of the lineshape and the width of the unresolved enveloped peak in the raw spectrum.

160. The method of claim 158 wherein the charge state is calculated using the width of the lineshape and the width of the deconvolved envelope with the lineshape.

161. The method of claim 158 wherein the charge state is calculated using the spacing between the peaks in a corrected deconvolved output within a cluster.

162. The method of claim 119 herein said computer system creates a list of 2D peaks in the spectrum by their positions and total intensities.

163. The method of claim 119 wherein said computer system creates a list of neutral mass components by their migration times and total intensities.

164. The method of claim 119 wherein said computer system aligns a plurality of lists of neutral masses or a plurality of lists of 2D peaks, wherein said lists provide location and total intensity for each neutral mass or 2D peak.

165. The method of claim 164 wherein said computer system can further collapse the list of 2D peaks to a list of neutral mass components.

166. A method comprising the steps of:
acidifying a sample;
providing a sample;
separating a composition from said sample;
analyzing separated sample using a mass analyzer;
scaling a mass spectrum generated by the mass analyzer;
deconvolving the scaled mass spectrum;
descaling the deconvolved mass spectrum;
deisotoping the descaled mass spectrum;
decharging the de-isotoped mass spectrum;
providing a list of 2D peaks;
providing a list of neutral mass components;
aligning a plurality of 2D peak lists or a plurality of neutral mass component lists.

167. The method of claim 166 further providing the step of acidifying said sample.

168. The method of claim 166 wherein said sample is derived from a mammal.

169. The method of claim 166 wherein said separating step separates samples <30 kDa.

170. The method of claim 166 wherein said deconvolving step involves the use of an algorithm selected from the group consisting of basis pursuit (one-norm penalty), Tikhonov regularization (two-norm penalty), maximum entropy (entropy penalty), and parametric deconvolution.

171. The method of claim 166 further comprising the step of providing a lineshape to said mass spectrum.

172. The method of claim 171 wherein said lineshape is determined from raw data.

173. The method of claim 171 further comprising the step of estimating one or more parameters that determine said lineshape.

174. The method of claim 171 wherein width of said lineshape varies linearly or quadratically as a function of time-of-flight.

175. The method of claim 171 wherein said lineshape varies deterministically along a time-of-flight axis.

176. The method of claim 171 wherein said scaling step scales said spectrum and lineshape along a time-of-flight axis.

177. The method of claim 172 wherein said deconvolving step further comprises estimating noise level.

178. The method of claim 177 wherein said noise level is used in an objective function calculation for said deconvolving step.

179. The method of claim 172 wherein said deconvolving step further comprises of the use of fast wavelet transform for convolution calculation.

180. The method of claim 172 wherein the said deconvolving step yields data with increased resolution.

181. The method of claim 180 wherein said resolution is increased by at least 1.5.

182. The method of claim 172 wherein the said deconvolving step reduces noise.

183. The method of claim 182 wherein said deconvolving step reduces noise by modifying the objective function to be a penalized log-likelihood function rather than a penalized least-squares problem.

184. The method of claim 172 wherein the said deconvolving step increases signal-to-noise ratio.

185. The method of claim 184 wherein said signal-to-noise ratio is increased by at least 2, 5, 10, or 50.

186. The method of claim 172 wherein deconvolved spectrum is corrected by using isotope distribution data to group deconvolved peaks into isotopic clusters.
